(19) United States
(12) Patent Application Publication
(10) Pub. No.: US 2019/0389638 A1
(43) Pub. Date: Dec. 26, 2019

(54) SEALING WITH FLEXIBLE GROOVED RINGS AND FOAM RINGS

(71) Applicant: HEWLETT-PACKARD DEVELOPMENT COMPANY, L.P., Spring, TX (US)

(72) Inventors: Segi Gonzalez Sanchez, Aguadilla (PR); Carlos E. Rosario, Aguadilla (PR); Javier A. Dominguez Maldonado, Aguadilla (PR)

(73) Assignee: HEWLETT-PACKARD DEVELOPMENT COMPANY, L.P., Spring, TX (US)

(21) Appl. No.: 16/481,609

(22) PCT Filed: Apr. 12, 2017
(86) PCT No.: PCT/US2017/027182

§ 371 Date: Jul. 29, 2019

(51) Int. Cl. B65D 53/02; F16J 15/02

(52) U.S. Cl. CPC B65D 53/02; F16J 15/104; F16J 15/022

(57) ABSTRACT

In one example in accordance with the present disclosure, a sealing system is described. The sealing system includes a flexible ring (104). The flexible ring has a first surface (214) having radial grooves (218-1) formed therein to seal against a first mating member (108) and a second surface (216) having radial grooves (218-2) formed therein to interface against a foam ring (106). The sealing system also includes the foam ring. The foam ring has a first surface to interface against the second surface of the flexible ring and a second surface to seal against a second mating member.

### BACKGROUND

Containers are used to hold any number of compositions. For example, an ink container holds fluid ink that can be used during printing operations. In other examples, different types of fluids, or solids, powders, etc. can be disposed within a container. A cap is disposed over an opening of the container so that the contents of the container can be accessed and so that the container can be closed to prevent leakage of the contents from the container. In some cases, the compositions may be prone to leaking if not properly contained within the container.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is an exploded isometric diagram of a container that includes a sealing system with a flexible grooved ring and a deformable foam ring, according to an example of the principles described herein.

FIG. 2 is a cross-sectional diagram of a sealing system with a flexible grooved ring and a deformable foam ring, as disposed within a cap of a container, according to an example of the principles described herein.

FIG. 3 is a close-up view of the sealing system as disposed within a cap of a container, according to an example of the principles described herein.

FIG. 4 is a cross-sectional diagram of a sealing system with a flexible grooved ring and a deformable foam ring, as it seals a cap and container, according to an example of the principles described herein.

FIG. 5 is a close-up view of the sealing system as it seals a cap and container, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Containers are used to hold any number of compositions. For example, an ink container holds fluid ink that can be used during printing operations. In other examples, different types of fluids, or solids, powders, etc. can be disposed within a container. A cap is disposed over an opening of the container so that the contents of the container can be accessed and so that the container can be closed to prevent leakage of the contents from the container. In some cases, the compositions may be prone to leaking if not properly contained within the container.

For example, caps may mate with the container in any number of ways. In one example, the cap has internal threading which interfaces with external threading on a spout of a container. As these threadings engage, the cap is maintained to cover the opening of the container. In another example, a cap is pushed onto the container. In this example, there is a retaining mechanism on one, or both of, the cap and container to retain the cap in place. This type of interface may be referred to as a snap fit interface. A snap fit interface allows for a desired rotational alignment of the cap and container. For example, in a threaded interface, while any rotational configuration may be possible, to achieve a desired rotational alignment, a seal to prevent leakage may be sacrificed.

While a snap fit interface does allow for precise radial alignment, there are some existing complications. For example, a snap fit type cap may result in a nominally constant gap between the cap and the container even when properly mated. While allowing for containment of the contents, such a system may still be susceptible to leaking through this gap. For example, an ink container may be disposed on its side, where the cap is horizontal, and prone to leakage. When the container is disposed on its side like this, the gap may not provide a seal and may provide a path through which the contents of the container may leak out. This is exacerbated when the contents of the container have a low viscosity, such as water, or ink that has been heated to a certain temperature. Accordingly, the present specification describes a system and container that address these and other complications.

Specifically, the present specification describes a face-type sealing system for sealing a pair of mating members, such as a cap and a container. The sealing system includes a flexible plastic ring that has grooves on both surfaces and a deformable foam ring that is adjacent to the flexible plastic ring. As the first mating member and second mating member are brought together, the foam ring deforms 1) against a surface of the second mating member on one surface and 2) against the set of grooves on one surface of the flexible plastic ring. Also during this mating, the flexible plastic ring 1) interfaces with the foam ring as described above and 2) flexes to match the contours of the first mating member. The grooves on the surface that seal against the first mating member 1) create a seal against the first mating member and 2) provide catches for excess fluid to be captured in the event of some leakage. While the present specification specifically describes a snap fit mating interface, the present system and container may be implemented with any type of mating interface including threaded mating interfaces.

Specifically, the present specification describes a sealing system that includes a flexible ring. The flexible ring includes a first surface having radial grooves formed therein to seal against a first mating member and a second surface having radial grooves formed therein to interface against a foam ring. The foam ring includes a first surface to interface against the second surface of the flexible ring and a second surface to seal against a second mating member. The two are disposed between the mating members to be joined. As the mating members are brought together, the flexible ring and foam ring are compressed to form a seal.

The present specification also describes a container sealing system. The container sealing system includes a flexible plastic ring. The flexible plastic ring includes a first surface having radial grooves formed therein to seal against a cap of a container and a second surface having radial grooves formed therein to interface against a foam ring. The system also includes a foam ring. The foam ring includes a first surface to interface against the second surface of the flexible ring and a second surface to seal against a spout of the container, which spout is mated with the cap.

The present specification also describes a container device. The container device includes a container to hold a volume of a composition and a cap to mate with the container. The device also includes a sealing system disposed within the cap. The sealing system includes a flexible plastic ring. The flexible plastic ring includes a first surface having radial grooves formed therein to seal against a cap of a container and a second surface having radial grooves formed therein to interface against a foam ring. The system also includes a foam ring. The foam ring includes a first surface to interface against the second surface of the flexible ring and a second surface to seal against a spout of the container, which spout is mated with the cap.

In summary, using such a sealing system 1) increases sealing performance in sealing two mating members, specifically within a snap fit sealing system; 2) seals members regardless of manufacturing imperfections on either; or both, of the first mating member and second mating member; and 3) provides a catch where excess fluid from within the container is retained during use. However, it is contemplated that the devices disclosed herein may address other matters and deficiencies in a number of technical areas.

As used in the present specification and in the appended claims, the term “a number of” or similar language is meant to be understood broadly as any positive number including 1 to infinity.

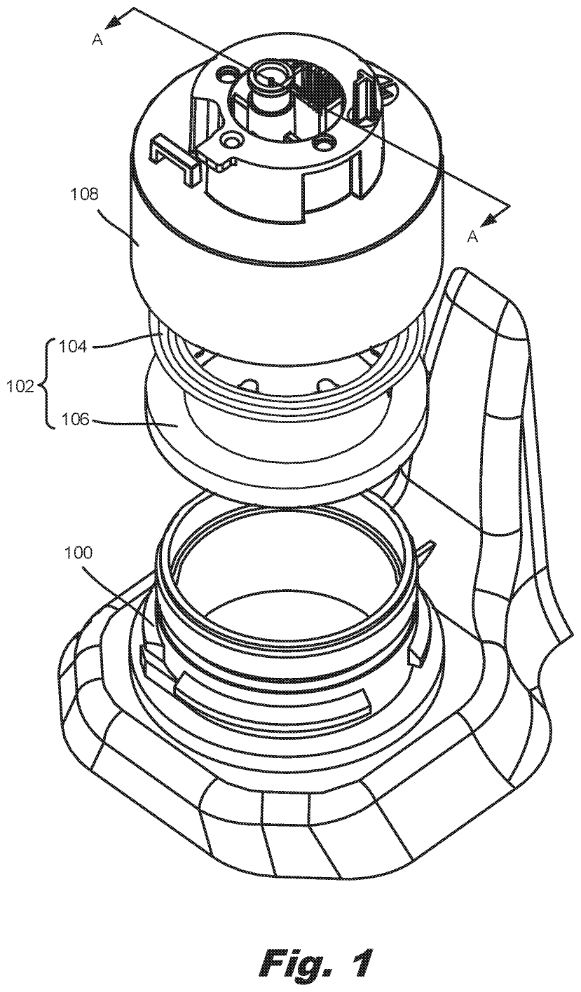

FIG. 1 is an exploded isometric diagram of a container device that includes a sealing system (102) with a flexible grooved ring (104) and a deformable foam ring (106), according to an example of the principles described herein. The device includes a container (100) to hold a volume of a composition. As described above, containers (100) hold any type of composition. While the present specification specifically describes an ink container (100), the sealing system (102) may be used with any type of container (100). The container (100) may be formed of any material. For example, the container (100) may be a blow-molded component formed of high-density polyethylene (HDPE). While specific reference is made to a particular material, any type of material may be used that can hold a volume of a composition.

The container device also includes a cap (108) to retain the contents of the container (100). Specifically, the cap (108) is disposed over a spout through which the contents are inserted into the container (100). In some examples, the cap (108) may include a passageway through which the interior contents of the container (100) are ejected. That is, in some cases, the cap (108) may be removed and the contents ejected and in other cases, the cap (108) is retained on the container (100), and the contents ejected through the passageway.

There are many types of mating interfaces between the cap (108) and the container (100). For example, the cap (108) may snap onto the container (100) by pressing the cap (108) and the container (100) together. In this example, there may be retention mechanisms on one of, or both, of the cap (108) and container (100) to retain them together. While this is one example of a mating interface, the sealing system (102) as described herein may apply to other mating interfaces as well, including threaded mating interfaces.

The interface may also be defined by the types of surfaces that are sealed. For example, a planer surface of a first mating member, i.e., the cap (108), may be sealed against a planar surface of a second mating member, i.e., a neck of the spout of the container (100). Sealing planer surfaces against each other may be referred to as a face-type seal. That is, the sealing system (102) may be a face-type seal between the first mating member and the second mating member. As used in the present specification and in the appended claims the first mating member and second mating member refer to components that are to be joined. While the specification specifically describes a cap (108) as a first mating member and a container (100) spout as a second mating member, the sealing system (102) described herein may be used with any type of mating members.

The sealing system (102) includes a flexible ring (104). The flexible ring (104) may be formed of a plastic such as polyethylene. Other examples of materials from which the flexible ring (104) may be formed include polypropylene and other polymerized low molecular mass olefins. While specific reference is made to a particular material, the flexible ring (104) may be formed out of a material that allows the ring (104) to flex to match the contours of the first mating member. For example, the cap (108), which is an example of a mating member may be injected molding, which manufacturing process may not maintain tight manufacturing tolerances. Specifically, due the mechanics of the injection molding process, there may be parting lines disposed on the interior surface of the cap (108) and there may be wavelike contours on this interior surface. These surface imperfections are sites that are prone to leakage due to the difficulty in sealing against them. However, by forming the flexible ring (104) out of a flexible material, when the ring (104) is pressed against the cap (108), for example upon mating with the container (100), the flexible ring (104) flexes against those contours in the cap (108), parting lines, and other imperfections and provides a more effective seal against content leakage. Accordingly, the flexible ring (104) is formed of a material that is softer than the cap (108), thus allowing the flexible ring (104) to flex while the cap (108) retains its form.

The flexible ring has a first surface that includes radial grooves and a second, and opposite, surface that also includes radial grooves. The radial grooves on the first surface, i.e., the surface that seals against the cap (108), push against the interior surface of the cap (108), thus providing a seal. That is, upon mating, the flexible ring (104) flexes and bends to align with the wavy contours and other surface imperfections that may exist on an interior surface of the first mating member, i.e., the cap (108). The grooves also serve as a catch for any excess fluid that may leak out. That is, in any application, despite all efforts, a small amount of the contents may leak out a seal. However, in this event, the grooves catch that excess fluid and prevent it from exiting the container device. In other words, before the contents of the container (100) leak out, they accumulate in the grooves, thereby preventing their leaking out of the container (100).

The sealing system (102) also includes a foam ring (106) having a first surface and a second surface. The foam ring (106) may be formed of a deformable material, such as foam. Specifically, the foam ring (106) may be formed of cross-linked polyethylene. Other examples of materials that may be used include ethylene propylene diene monomer (EPDM) foams and cross-linked ethylene vinyl acetate foam. The first surface of the foam ring (106) interfaces with the second surface of the flexible ring (104), which is the surface of the flexible ring (104) that is not in contact with the cap (108). In general, the foam ring (106) is formed of a material that is softer than the flexible ring (104) and that is softer than the container (100). Accordingly, when during the mating process, the foam ring (106) is compressed against the flexible ring (104), the foam ring (106) deforms into the grooves on the second surface of the flexible ring (104), and the flexible ring (104) does not deform. Similarly, as the foam ring (106) is softer than the material of the container (100), during the mating process, the foam ring (106) is compressed against the second mating member, i.e., the neck of the spout of the container (100) and the container (100) does not deform. Thus, a seal is created between a first mating member and a second mating member, i.e., the cap (108) and container (100).

The foam ring (106) and the flexible ring (104) may be formed of materials that are resistant to degradation caused by ink. As described above, the contents of the container (100) may be ink. Ink may interact with certain materials and degrade those materials. That is incompatibility between the ink and the component materials can translate into undesired changes in component dimensions, mechanical properties, time-dependent properties and/or structural integrity. Accordingly, the material of each component of the sealing system (102) may be selected to resist such degradation. For example, the flexible ring (104) and the foam ring (106) may be formed out of polyethylene and cross-linked polyethylene, each which resist such degradation.

The sealing system (102) as described herein increases sealing performance while allowing for precision radial alignment of two mating members. It does so by sealing interfaces that may have imperfect sealing surfaces. More specifically, in forming an injection-molded cap (108), plastic sinking and the presence of small parting lines result in a sealing surface that is imperfect. Similarly, the operations of forming a blow-molded container (100) may result in mating surfaces on the spout of the container (100) that are also imperfect. However, by relying on a flexible ring (104) to conform to these contours, and a deformable ring (106) that deforms to the imperfections on the container (100) spout, an efficient seal can be provided notwithstanding these imperfections. Moreover, the sealing system (102) provides an effective seal where an opening is to provide access to the container without blocking it at any time.

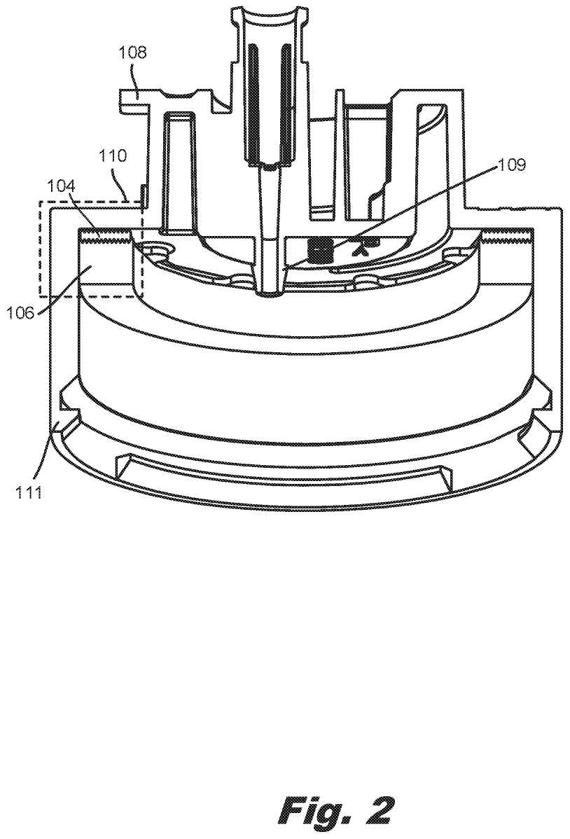

FIG. 2 is a cross-sectional diagram of a sealing system (FIG. 1, 102) with a flexible grooved ring (104) and deformable foam ring (106), according to an example of the principles described herein. Specifically, FIG. 2 is a cross-sectional diagram taken along the line A-A in FIG. 1. As described above, the cap (108) may remain in place while the contents are being extracted. For example, the cap (108) may contain a nozzle (109) through which the contents are extracted. That is, in use, the cap (108) remains in place covering the opening.

The cap (108) may cover a spout in a container (100) and may be a snap-fit into place. That is, in some cases, the cap (108) is threadless, and not rotated into place, but simply pressed into place. Accordingly, the cap (108) includes a cap retention mechanism (111) that interfaces with a corresponding container retention mechanism to mate the cap (108) to the container (FIG. 1, 100). A snap fit mating interface allows the cap (108) to be rotationally aligned with the container (FIG. 1, 100) to a particular orientation. For example, in a threaded interface, it is possible that the rotational position of the cap (108) with regards to the container (FIG. 1, 100) will not provide a seal while maintaining a desired rotational alignment. Accordingly, a snap fit interface of the cap (108) onto the container (FIG. 1, 100) provides such precise alignment of the cap (108) and the container (FIG. 1, 100) all while providing a seal. As seen in FIG. 2, in some cases, the sealing system (FIG. 1, 102) is disposed within the cap (108). For example, the flexible grooved ring (104) and the deformable foam ring (106) may be press fit into the cap (108) and retained in place due to frictional forces between the interior sidewalls of the cap (108) and the outside surfaces of the flexible ring (104) and deformable foam ring (106).

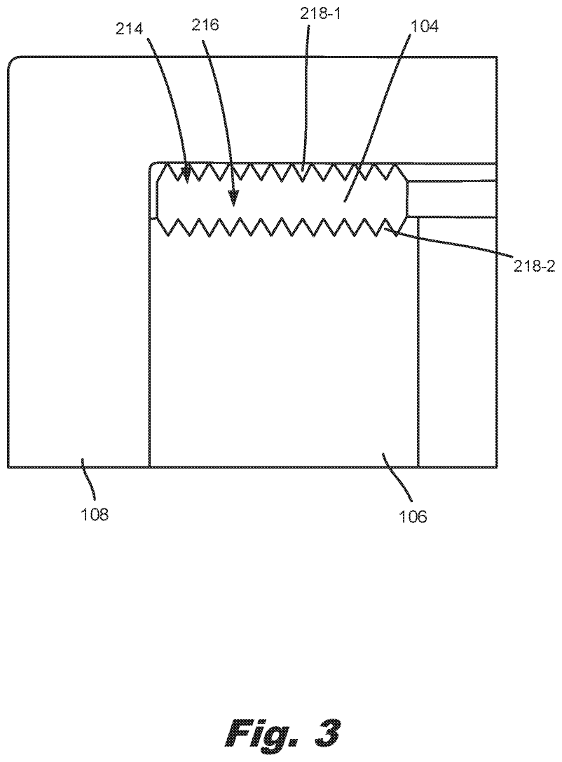

FIG. 3 is a close-up view of the sealing system (FIG. 1, 102) as disposed within a cap (FIG. 1, 108) of a container (FIG. 1, 100), according to an example of the principles described herein. Specifically, FIG. 3 corresponds to the dashed box (110) in FIG. 2. FIG. 3 illustrates the interaction between the components of the sealing system (FIG. 1, 102) during mating of the first mating member and the second mating member.

As described above, the flexible ring (104) includes a first set of radial grooves (218-1) disposed on a first surface (214) and a second set of radial grooves (218-2) disposed on a second surface (216). The radial grooves (218) are individual radial races along the respective surfaces (214, 216).

The grooves (218-1) on the first surface (214) interface with a first mating member based on mechanical pressure exerted during mating. That is, as described above, a snap mating interface between the first mating member and second mating member may result in a predefined gap between the first mating member and the second mating member. The combined thickness of the sealing system (FIG. 1, 102) may be greater than this thickness such that before the cap (108) is fully mated with the container (FIG. 1, 100), the deformable foam ring (106) and the flexible ring (104) are subject to mechanical compression forces. Due to this mechanical compression, the ridges that define the first set of grooves (218-1) contact the contours of the first mating member i.e., the cap (108). As the flexible ring (104) is formed of a material that is softer than the cap (108), the cap (108) does not flex, but the flexible ring (104) does. By so flexing, the ridges are in constant contact with the interior surface of the cap (108) thus ensuring a proper seal there between. That is, the contact between the ridges and the cap (108) surface creates a seal through which fluid, or other materials, cannot easily travel. However, in case some fluid does get past a particular ridge, this fluid is caught and retained in a groove (218). In other words, each groove (218), in addition to providing a sealing surface, also provides a basin in which leaking composition is captured before it exits the container (FIG. 1, 100).

A second surface (216) of the flexible ring (104) also includes grooves (218-2). This second set of grooves (218-2) interface with the deformable foam ring (106) to generate an additional seal. For example, the deformable foam ring (106) being softer than the plastic ring (104) and deformable, deforms against the second set of grooves (218-2) as they are forced together during the mating of the first mating member and the second mating member.

In some examples, the radial grooves (218) may be any size sufficient to provide the flexibility to allow the flexible ring (104) to flex against the contours of the cap (108) while providing sufficient strength to effectively seal against the first mating member. In one example, the radial grooves (218) are greater than 0.25 millimeters deep. The grooves (218) may also be less than 0.75 millimeters deep. While specific reference is made to particular heights of the grooves (218), any height may be used for the grooves (218).

As depicted in FIG. 3, the flexible ring (104) may be thinner than the deformable foam ring (106). For example, the deformable foam ring (106) may be at least three times thicker than the flexible ring (104). For example, the flexible ring may be 2.5 millimeters thick, and the deformable foam ring (106) may be between six and nine millimeters thick.

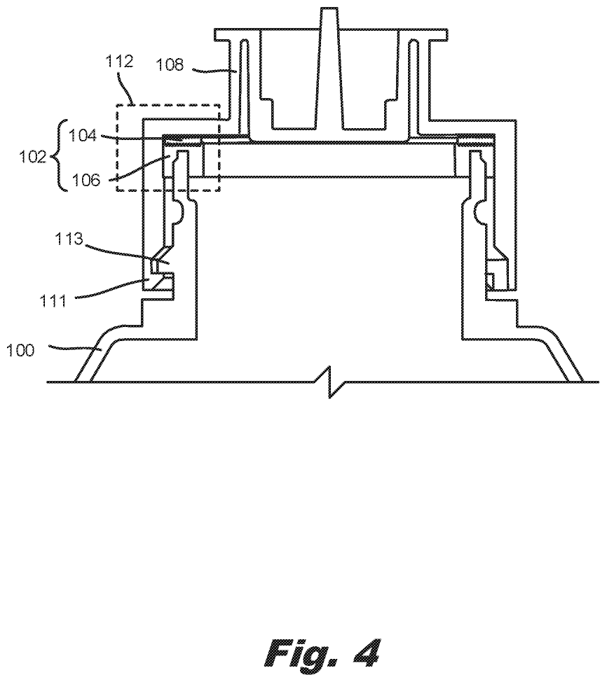

FIG. 4 is a cross-sectional diagram of a sealing system (102) with a flexible grooved ring (104) and a deformable foam ring (106), as it seals a cap (108) and container (100), according to an example of the principles described herein. Note that while FIG. 4 depicts a cap (108) and a container (100) as the first mating member and the second mating member, any type of structure may be mated using the system (102) described herein.

As described above, the cap (108) and container (100) may be snap fit together. Accordingly, the cap (108) includes a cap retention mechanism (111) that interfaces with a container (100) retention mechanism (113). While FIG. 4 depicts a particular retention system, any type of retention system may be used.

As described above, the sealing system (102) is compressed between surfaces of a cap (108) and a container (100). That is, the thickness of the combined flexible ring (104) and deformable foam ring (106) may be greater than the nominal gap between a mated cap (108) and container (100). Accordingly, as the cap (108) and container (100) are brought together, the deformable foam ring (106) and the flexible grooved ring (104) are compressed 1) between the cap (108) and the container (100), and 2) against each other. Doing so ensures a tight seal between the cap (108) and the container (100).

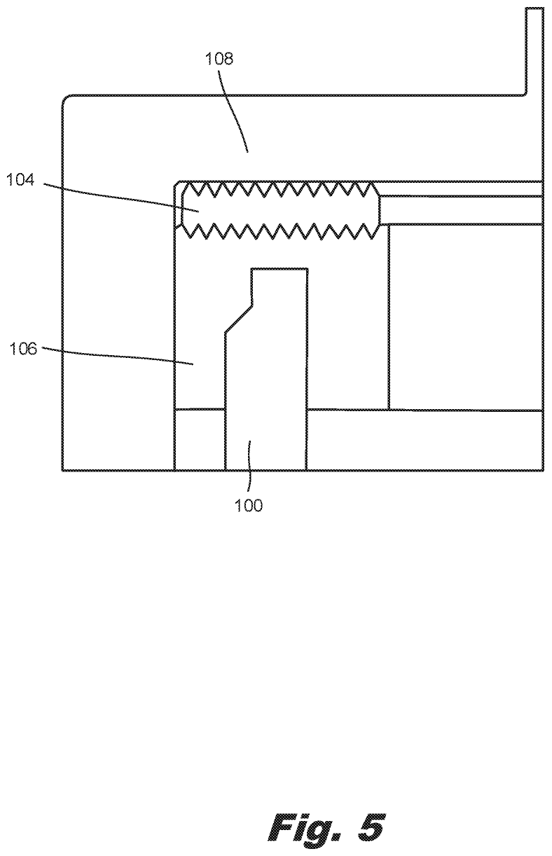

FIG. 5 is a close-up view of the sealing system (FIG. 1, 102) as it seals a cap (108) and container (100), according to an example of the principles described herein. Specifically, FIG. 5 corresponds to the dashed box (112) in FIG. 4. As can be seen in FIG. 5, upon mating the first set of radial grooves (FIG. 2, 218-1) are snug against the first mating member, notwithstanding any surface imperfections on the first mating member, thus creating a more efficient seal there between. Also, the deformable foam ring (106) is deformed into the flexible ring (104) preventing fluid travel there between. FIG. 5 also depicts the deformation of the second surface of the deformable foam ring (106) against the neck of the spout of the container (100). That is, the deformable foam ring (106), as the first mating member and second mating member are joined, conforms to the shape of the neck of the spout of the container (100). Doing so, compresses the matrix of the deformable foam ring (106) such that fluid cannot pass through. Thus, as is clearly illustrated here, any fluid inside the container (100) is prevented from inadvertently leaking due to the seals generated by the deformable foam ring (106) against the container (100) opening, between the deformable foam ring (106) and the flexible ring (104), and between the flexible ring (104) and the cap (108).

In summary, using such a sealing system 1) increases sealing performance in sealing two mating members, specifically within a snap fit seal system; 2) seals members regardless of manufacturing imperfections on either of the first mating member and second mating member; and 3) provides a catch where excess fluid from within the container is retained during use. However, it is contemplated that the devices disclosed herein may address other matters and deficiencies in a number of technical areas.

The preceding description has been presented to illustrate and describe examples of the principles described. This description is not intended to be exhaustive or to limit these principles to any precise form disclosed. Many modifications and variations are possible in light of the above teaching.

What is claimed is:

1. A sealing system comprising:
a flexible ring comprising:
a first surface having radial grooves formed therein to seal against a first mating member; and
a second surface having radial grooves formed therein to interface against a foam ring; and
the foam ring comprising:
a first surface to interface against the second surface of the flexible ring; and
a second surface to seal against a second mating member.

2. The system of claim 1, wherein the sealing system is a face-type seal between planer surfaces of the first mating member and second mating member.

3. The system of claim 1, wherein:
the first mating member is a cap; and
the second mating member is a container to mate with the cap.

4. The system of claim 1, wherein as the first mating member is coupled to the second mating member:
the flexible ring flexes against a contour of the first mating member;
the first surface of the foam ring deforms against the radial grooves of the second surface of the flexible ring; and
the second surface of the foam ring deforms against the second mating member.

5. The system of claim 1, wherein the foam ring is at least three times thicker than the flexible ring.

6. The system of claim 1, wherein the flexible ring is formed of plastic.

7. The system of claim 1, wherein the foam ring is formed of cross-linked polyethylene.

8. A container sealing system comprising:
a flexible plastic ring comprising:
a first surface having radial grooves formed therein to seal against a cap of a container; and
a second surface having radial grooves formed therein to interface against a foam ring; and
the foam ring comprising:
a first surface to interface against the second surface of the flexible plastic ring; and
a second surface to seal against a spout of the container, which spout is mated with the cap.

9. The system of claim 8; wherein the radial grooves are greater than 0.25 millimeters deep.

10. The system of claim 8, wherein the radial grooves are less than 0.75 millimeters deep.

11. The system of claim 8, wherein the foam ring is between six and nine millimeters thick.

12. The system of claim 8, wherein the foam ring and the flexible ring are formed of a material resistant to degradation caused by ink.

13. A container comprising:
a container to hold a volume of a composition;
a cap to mate with the container;
a sealing system disposed within the cap, the sealing system comprising:
a flexible plastic ring comprising:
a first surface having radial grooves formed therein to seal against a cap of a container; and
a second surface having radial grooves formed therein to interface against a foam ring; and
the foam ring comprising:
a first surface to interface against the second surface of the deformable plastic ring; and
a second surface to seal against a spout of the container, which spout is mated with the cap.

14. The container of claim 13, wherein:
the foam ring is formed of a material that is softer than:
a material that forms the flexible plastic ring; and
a material that forms the spout; and
the flexible plastic ring is formed of a material that is softer than the cap.

15. The container of claim 13, wherein the sealing system prevents leakage as the cap is snap-fit onto the container.
